(19) United States
(12) Patent Application Publication
(10) Pub. No.: US 2022/0104317 A1
(43) Pub. Date: Mar. 31, 2022

(54) MICROWAVE COOKING APPLIANCE

(71) Applicants: GUANGDONG MIDEA KITCHEN APPLIANCES MANUFACTURING CO., LTD., FOSHAN (CN); MIDEA GROUP CO., LTD., FOSHAN (CN)

(72) Inventors: Modam JOO, FOSHAN (CN); Li Hong, FOSHAN (CN)

(21) Appl. No.: 17/412,209

(22) Filed: Aug. 25, 2021

(30) Foreign Application Priority Data
Sep. 27, 2020 (CN) 202011034690.4

(51) Int. Cl. H05B 6/64; H05B 6/78; B21D 22/02

(52) U.S. Cl. CPC H05B 6/6411; B21D 22/02; H05B 6/782

(57) ABSTRACT

The present disclosure discloses a cooking appliance, which includes: a cooking chamber; a tray, which is arranged at a bottom of the cooking chamber; a drive mechanism, which is connected with the tray and which is configured to drive the tray to rotate; and a protrusion, which is formed on a bottom plate of the cooking chamber, and which is located below the tray and near an edge of the tray. The cooking appliance of the embodiment of the present disclosure also has a protrusion formed on the bottom plate of the cooking chamber, and the protrusion is arranged below the tray, which greatly limits a space in which the tray can deflect. Therefore, when the tray has a tendency of turning over under the action of an external force, the tray can only move with a small amplitude, and when it contacts the protrusion, it will immediately have a tendency of moving back to its original position.

### CROSS-REFERENCES TO RELATED APPLICATIONS

The present application claims benefit of Chinese Application No. 202011034690.4, filed on Sep. 27, 2020, the contents of which are hereby incorporated by reference in its entirety.

### FIELD

The present disclosure relates to the field of household appliances, and in particular to a cooking appliance.

### BACKGROUND

This section provides only background information related to the present disclosure, which is not necessarily the prior art.

In some existing cooking appliances (such as microwave ovens, oven-microwave integrated machines, etc.), food is placed on a rotatable tray during the process of heating the food, and the tray is driven to rotate while the food is being heated, so that the food is evenly heated. In order to facilitate the cleaning of the tray, the tray and a drive shaft that drives the tray to rotate are separable, so there is a problem of unstable placement of the tray. If an edge of the tray is pressed downward, the tray may turn over. Once the user accidentally applies a downward pressure on the edge of the tray during the process of taking out the food after completion of heating, the tray may turn over, which may cause the food to displace or fall out of a container and scald the user. Especially when a heating object is liquid, it is more likely to scald the user. Therefore, this kind of tray that cannot be stably enough placed has safety hazards.

### SUMMARY

The present disclosure aims to at least solve the problem that the trays of existing cooking appliances may easily turn over when subjected to a downward pressure, which will cause the risk of scalding.

An embodiment of the present disclosure provides a cooking appliance, which includes: a cooking chamber; a tray, which is arranged at a bottom of the cooking chamber; a drive mechanism, which is connected with the tray and which is configured to drive the tray to rotate; and a protrusion, which is formed on a bottom plate of the cooking chamber, and which is located below the tray and near an edge of the tray.

The cooking appliance according to the embodiment of the present disclosure is provided with a tray at the bottom of the cooking chamber, and at the same time is provided with a drive mechanism that can drive the tray to rotate. The user can place the food to be heated on the tray. After the cooking appliance is turned on, the drive mechanism is used to drive the tray to continuously rotate, and driving the tray to rotate while the food is being heated, so that the food is heated evenly. In addition, the cooking appliance of the embodiment of the present disclosure also has a protrusion formed on the bottom plate of the cooking chamber, and the protrusion is arranged below the tray, which greatly limits a space in which the tray can deflect. Therefore, when the tray has a tendency of turning over under the action of an external force, the tray can only move with a small amplitude, and when it contacts the protrusion, it will immediately have a tendency of moving back to its original position. In this way, the placement stability of the tray is significantly improved, and the possibility of the risk of scalding caused by the overturning of the tray is reduced. In addition, by arranging the protrusion near the edge of the tray, the protrusion can have the largest support arm of force relative to a center of the tray, so that the protrusion can sufficiently resist a very large overturning moment that causes the tray to have the tendency of turning over, and the stability of the tray is increased to the maximal extent.

In addition, the cooking appliance according to the embodiment of the present disclosure may also have the following additional embodiments.

In some embodiments of the present disclosure, the protrusion is an arc-shaped protruding structure extending in a circumferential direction of the tray.

In some embodiments of the present disclosure, the number of the arc-shaped protruding structure is two, and the two arc-shaped protruding structures are distributed on the same circumference and arranged at an interval of 180°.

In some embodiments of the present disclosure, an arc center angle of the arc-shaped protruding structures is larger than or equal to 90°.

In some embodiments of the present disclosure, the number of the arc-shaped protruding structure is three or four, and all the arc-shaped protruding structures are distributed on the same circumference and arranged at an equal angular interval.

In some embodiments of the present disclosure, the protrusion is formed by drawing the bottom plate.

In some embodiments of the present disclosure, the drive mechanism includes: a motor bracket, which is arranged below the bottom plate; a motor, which is connected to the motor bracket; and a drive shaft, which is connected with an output shaft of the motor so that the motor drives the tray to rotate through the drive shaft.

In some embodiments of the present disclosure, the drive shaft includes a shaft member and a drive portion arranged coaxially with the shaft member, the shaft member is connected with the output shaft of the motor, the drive portion is formed with drive teeth, and inter-teeth grooves are formed between adjacent drive teeth; raised structures are formed at a bottom of the tray, and each of the raised structures is arranged in a corresponding one of the inter-teeth grooves.

In some embodiments of the present disclosure, the motor bracket is a hood-shaped structure, a cavity is formed between the motor bracket and the bottom plate, and a through hole communicating with the cavity is provided on the motor bracket.

In some embodiments of the present disclosure, the cooking appliance further includes a rotating ring arranged between the bottom plate and the tray, and the rotating ring includes a ring-like body and rollers connected to the ring-like body.

### BRIEF DESCRIPTION OF THE DRAWINGS

Embodiments of the present disclosure will become apparent and easy to understand from the description of the embodiments in conjunction with the accompanying drawings below, in which:

FIG. 1 is a schematic structural view of a cooking appliance according to an embodiment of the present disclosure (partial structure shown in an exploded view);

FIG. 2 is a partially enlarged schematic view of the structure shown in FIG. 1;

FIG. 3 is another partially enlarged schematic view of the structure shown in FIG. 1;

FIG. 4 is a schematic top view of the structure of the cooking appliance according to the embodiment of the present disclosure;

FIG. 5 is a schematic cross-sectional view taken along line A-A in FIG. 4; and

FIG. 6 is a partially enlarged schematic view of the structure shown in FIG. 5.

### REFERENCE SIGNS

100: cooking appliance;
10: cooking chamber;
11: bottom plate;
20: tray;
21: raised structure;
30: drive mechanism;
31: motor bracket; 311: cavity; 312: through hole; 313: connecting portion; 314: connecting hole; 32: motor; 321: output shaft; 33: drive shaft; 331: shaft member; 332: drive portion; 3321: drive tooth; 3322: inter-teeth groove;
40: protrusion;
50: rotating ring;
51: ring-like body; 52: roller.

### DETAILED DESCRIPTION OF THE DISCLOSURE

Hereinafter, exemplary embodiments of the present disclosure will be described in more detail with reference to the accompanying drawings. Although the exemplary embodiments of the present disclosure are shown in the drawings, it should be understood that the present disclosure may be implemented in various forms and should not be limited by the embodiments set forth herein.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “above”, “over”, etc. These spatial relative terms are intended to include different orientations of the device in use or operation in addition to the orientation depicted in the drawings. For example, if the device in the figure is turned over, then elements described as “below other elements or features” or “under other elements or features” will be oriented as “above the other elements or features” or “over the other elements or features”. Thus, the exemplary term “below” may include orientations of both above and below. The device can be otherwise oriented (rotated by 90 degrees or in other directions), and the spatial relationship descriptors used herein will be explained accordingly.

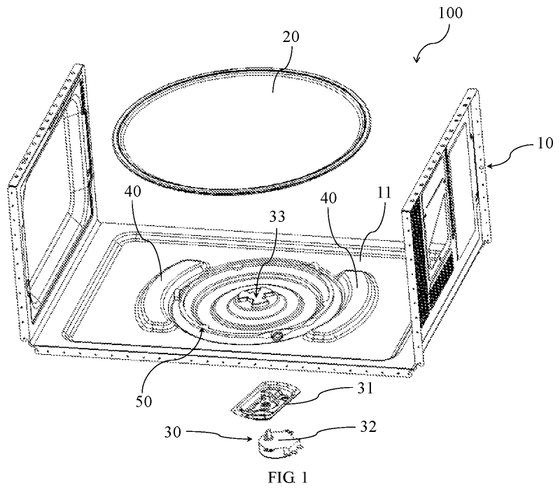

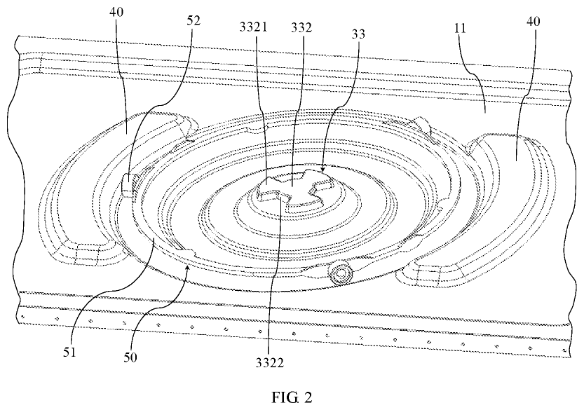

As shown in FIGS. 1 and 2, an embodiment of the present disclosure proposes a cooking appliance (such as a microwave oven, an oven-microwave integrated machine, etc.) 100, which includes a cooking chamber 10, a tray 20, a drive mechanism 30 and a protrusion 40. In one embodiment, the tray 20 is provided at a bottom of the cooking chamber 10; the drive mechanism 30 is connected with the tray 20 and is configured to drive the tray 20 to rotate; and the protrusion 40 is formed on a bottom plate 11 of the cooking chamber 10, and is located below the tray 20 and near an edge of the tray 20.

The cooking appliance 100 according to the embodiment of the present disclosure is provided with a tray 20 at the bottom of the cooking chamber 10, and at the same time is provided with a drive mechanism 30 that can drive the tray 20 to rotate. The user can place the food to be heated on the tray 20. After the cooking appliance 100 is turned on, the drive mechanism 30 is used to drive the tray 20 to continuously rotate, and driving the tray 20 to rotate while the food is being heated, so that the food is heated evenly. In addition, the cooking appliance 100 of the embodiment of the present disclosure also has a protrusion 40 formed on the bottom plate 11 of the cooking chamber 10, and the protrusion 40 is arranged below the tray 20, which greatly limits a space in which the tray 20 can deflect. Therefore, when the tray 20 has a tendency of turning over under the action of an external force, the tray 20 can only move with a small amplitude, and when it contacts the protrusion 40, it will immediately have a tendency of moving back to its original position. In this way, the placement stability of the tray 20 is significantly improved, and the possibility of the risk of scalding caused by the overturning of the tray 20 is reduced. In addition, by arranging the protrusion 40 near the edge of the tray 20, the protrusion 40 can have the largest support arm of force relative to a center of the tray 20, so that the protrusion 40 can sufficiently resist a very large overturning moment that causes the tray 20 to have the tendency of turning over, and the stability of the tray 20 is increased to the maximal extent.

In some embodiments of the present disclosure, the tray 20 is a glass tray, which has the advantages of being easy to clean and safe to use.

In some embodiments of the present disclosure, the protrusion 40 is an arc-shaped protruding structure extending in a circumferential direction of the tray 20. In this embodiment, the protrusion 40 adopts an arc-shaped protruding structure and extends in the circumferential direction of the tray 20. In this way, on one hand, the protrusion 40 can be hidden below the tray 20, so that the arrangement of the protrusion 40 will not cause the volume of the cooking chamber 10 to become smaller. On the other hand, in a case of the same extension length of the protrusion 40, extending in the circumferential direction of the tray 20 will enable the support effect of the protrusion 40 on the tray 20 to cover a larger angle range as much as possible.

In a specific example, the number of the arc-shaped protruding structure is two, and the two arc-shaped protruding structures are distributed on the same circumference and arranged at an interval of 180°. In this embodiment, there are two arc-shaped protruding structures, and the two arc-shaped protruding structures can support the tray 20 at two orientations of the tray 20. Moreover, since the arc-shaped protruding structures have a extension length, the support effect is not limited to the two orientations. It can be understood that the longer the extension length of the arc-shaped protruding structure is, the larger the range covered by the support effect of the tray 20 will be.

Further, an arc center angle of the arc-shaped protruding structure is larger than or equal to 90°, and in a case where the number of arc-shaped protruding structures is two and the two arc-shaped protruding structures are arranged at an interval of 180°, if the arc center angle of each arc-shaped protruding structure is larger than or equal to 90°, it will be difficult for the tray 20 to turn over toward an area where there is no arc-shaped protruding structure provided. This is because when the arc center angle of each arc-shaped protruding structure is larger than or equal to 90°, the central angle corresponding to a blank area between the two arc-shaped protruding structures is smaller than 90°, and this space is relatively small for the tray 20. If the tray 20 turns over to this smaller space, a very large overturning moment is required. Therefore, under the above conditions, the placement stability of the tray 20 can be significantly improved and the possibility of overturning the tray 20 is reduced.

In some other specific examples, the number of the arc-shaped protruding structure is three or four, and regardless of whether three or four arc-shaped protruding structures are provided, all of them are distributed on the same circumference and arranged at an equal angular interval. In other words, if the number of the arc-shaped protruding structures is three, then the interval angle between every two arc-shaped protruding structures is 120°, and if the number of the arc-shaped protruding structures is four, then the interval angle between every two arc-shaped protruding structures is 90°. As a result, the placement stability of the tray 20 can also be greatly improved, making it difficult for the tray 20 to turn over.

In some embodiments of the present disclosure, the protrusion 40 is formed by drawing the bottom plate 11. In one embodiment, an upwardly raised bulge structure is processed on the bottom plate 11 as a sheet metal by using a drawing process, and forming the protrusion 40. This method of processing the protrusion 40 on the bottom plate 11 by using the drawing process is advantageous for saving materials.

In some other embodiments of the present disclosure, a component with a height may be installed on the bottom plate 11 to form the protrusion 40. This method of forming the protrusion 40 by installing an additional component has a lower requirement on the processing accuracy of the bottom plate 11, and makes it easy to improve the yield of product.

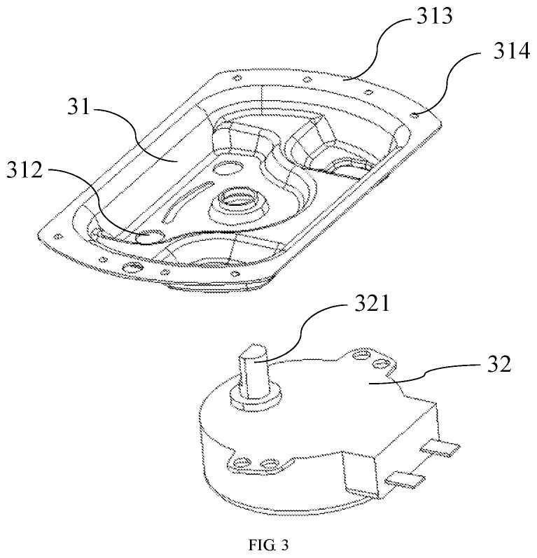

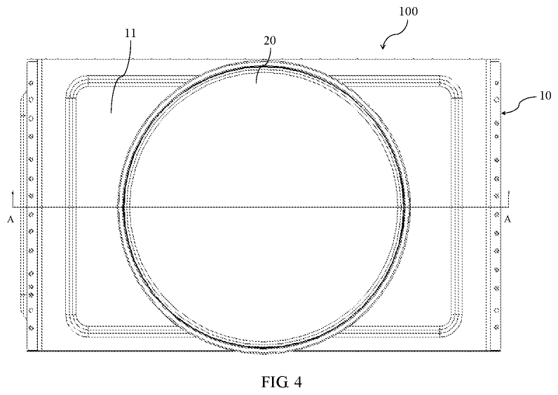

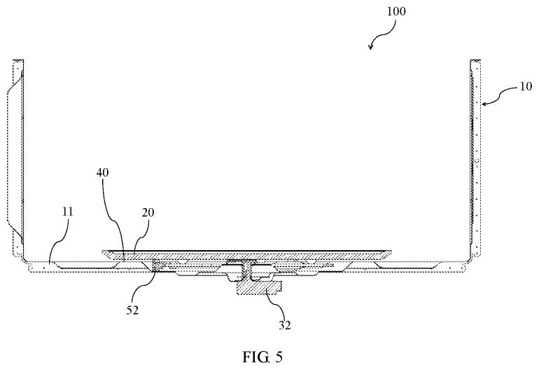

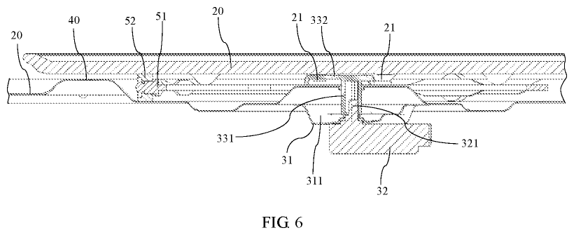

In some embodiments of the present disclosure, as shown in FIGS. 3 to 6, the drive mechanism 30 includes a motor bracket 31, a motor 32, and a drive shaft 33. The motor bracket 31 is arranged below the bottom plate 11, the motor 32 is connected to the motor bracket 31, and the drive shaft 33 is connected to an output shaft 321 of the motor 32. The drive shaft 33 penetrates through the bottom plate 11, and the motor 32 drives the tray 20 to rotate through the drive shaft 33. During the operation of the motor 32, the output shaft 321 of the motor 32 drives the drive shaft 33 to rotate, and the drive shaft 33 further drives the tray 20 to rotate while rotating.

In some embodiments of the present disclosure, the drive shaft 33 includes a shaft member 331 and a drive portion 332 arranged coaxially with the shaft member 331. The shaft member 331 is connected to the output shaft 321 of the motor 32, drive teeth 3321 are formed on the drive portion 332, and inter-teeth grooves 3322 are formed between adjacent drive teeth 3321. Raised structures 21 are formed on the bottom of the tray 20, and each of the raised structures 21 is arranged in a corresponding one of the inter-teeth grooves 3322. In this embodiment, the plurality of raised structures 21 at the bottom of the tray 20 are placed in the inter-teeth grooves 3322 of the drive portion 332 of the drive shaft 33 in a one-to-one correspondence. In this way, a constraint in the rotational direction is formed between the drive teeth 3321 of the drive portion 332 and the tray 20; that is, the tray 20 cannot rotate freely relative to the drive portion 332 in the direction around its own axis, so that the drive shaft 33 can drive the tray 20 to rotate. At the same time, the degree of freedom of movement of the tray 20 in the height direction is not restricted, and the user can lift the tray 20 upward to disengage the raised structures 21 at the bottom of the tray 20 from the inter-teeth groove 3322 of the drive portion 332. Then, the tray 20 can be taken out of the cooking chamber 10 to facilitate the user to clean the tray 20.

It is easy to understand that the shaft member 331 may be directly connected to the output shaft 321 of the motor 32, or may be connected to the output shaft 321 of the motor 32 through a connector (e.g., a coupling). However, regardless of which connection method is adopted, the shaft member 331 and the output shaft 321 of the motor 32 need to be in a coaxial relationship, that is, their axes have to coincide with each other.

Further, the number of drive teeth 3321 is plural, namely, at least two; that is, the case of two drive teeth 3321 is the minimum requirement to ensure that the drive shaft 33 can drive the tray 20 to rotate continuously. In addition, the case of three drive teeth 3321 is one embodiment. In this case, not only it can be ensured that the drive shaft 33 can drive the tray 20 to rotate continuously, but also the processing workload of manufacturing the drive shaft 33 will not be significantly increased.

In some embodiments of the present disclosure, the motor bracket 31 is a hood-shaped structure, a cavity 311 is formed between the motor bracket 31 and the bottom plate 11, and a through hole 312 communicating with the cavity 311 is provided on the motor bracket 31. In this embodiment, after the motor bracket 31 with the hood-shaped structure is installed on the bottom plate 11, a cavity 311 is formed between the motor bracket 31 and the bottom plate 11. The arrangement of the cavity 311 can insulate the transfer of heat to a extent. Therefore, when the cooking appliance 100 is working, the high temperature in the cooking chamber 10 will not be transmitted to the motor 32, so that the motor 32 can be protected. In addition, the motor bracket 31 is provided with a through hole 312 communicating with the cavity 311. The arrangement of the through hole 312 allows air to circulate inside and outside the cavity 311, and enabling hot air in the cavity to be released through the through hole 312, which is advantageous for heat dissipation of the motor 32.

Further, a connecting portion 313 is formed at the edge of the motor bracket 31, and connecting holes 314 are provided on the connecting portion 313. The connecting portion 313 can be connected to the bottom plate 11 of the cooking chamber 1 through fasteners (such as screws, pins, etc.) passing through the connecting holes 314 to realize the installation of the motor bracket 31 on the bottom plate 11.

In some embodiments of the present disclosure, the cooking appliance 100 further includes a rotating ring 50 arranged between the bottom plate 11 and the tray 20, and the rotating ring 50 includes a ring-like body 51 and rollers 52 connected to the ring-like body 51. In one embodiment, the bottom of the roller 52 sits on the bottom plate 11, and at the same time, the top of the roller 52 supports the tray 20. When the drive mechanism 30 drives the tray 20 to rotate, the rollers 52 have a support effect on the tray 20. Since the position where the food is placed on the tray 20 may be eccentric to a extent, the tray 20 may be unstable during the rotation, so there is a risk of overturning. It can be seen that the rollers 52 are mainly configured to improve the stability of the tray 20 during the rotation, and to prevent the tray 20 from overturning during the rotation. In addition, the rollers 52 are configured to support the tray 20 during the rotation of the tray 20, which may not increase the product cost significantly.

It should be noted that the function of the protrusion 40 is different from that of the rollers 52 of the rotating ring 50. In one embodiment, the rollers 52 are in contact with the tray 20 at every moment, and the protrusion 40 has a gap with the tray 20 when the tray 20 is placed stably, but does not contact the tray 20. The protrusion 40 will support the tray 20 only when the tray 20 is deflected, so that the tray 20 can quickly return to a stable state. Furthermore, the protrusion 40 is mainly configured to prevent the tray 20 from turning over when the user takes out the food, that is, the stage in which the tray 20 performs the support function is different from that of the rollers 50.

Further, the number of the rollers 52 is at least three (for example, three, four, or five, etc.), so that a relatively stable support structure can be formed. In a specific example, the number of the rollers 52 is three, and the three rollers 52 are distributed at an equal angular interval on the ring-like body 51, that is, the angular interval between any two rollers 52 is 120°. At this time, the number of rollers 52 is relatively small, which is advantageous for saving product cost and can also provide a stable support for the tray 20.

What is claimed is:

1. A cooking appliance, comprising:
a cooking chamber;
a tray, which is arranged at a bottom of the cooking chamber;
a drive mechanism, which is connected with the tray and which is configured to drive the tray to rotate; and
a protrusion, which is formed on a bottom plate of the cooking chamber, and which is located below the tray and near an edge of the tray.

2. The cooking appliance according to claim 1, wherein the protrusion is an arc-shaped protruding structure extending in a circumferential direction of the tray.

3. The cooking appliance according to claim 2, wherein a number of the arc-shaped protruding structure is two, and the two arc-shaped protruding structures are distributed on the same circumference and arranged at an interval of 180°.

4. The cooking appliance according to claim 3, wherein an arc center angle of the arc-shaped protruding structures is larger than or equal to 90°.

5. The cooking appliance according to claim 2, wherein a number of the arc-shaped protruding structure is three or four, and all the arc-shaped protruding structures are distributed on the same circumference and arranged at an equal angular interval.

6. The cooking appliance according to claim 1, wherein the protrusion is formed by drawing the bottom plate.

7. The cooking appliance according to claim 1, wherein the drive mechanism comprises:
a motor bracket, which is arranged below the bottom plate;
a motor, which is connected to the motor bracket; and
a drive shaft, which is connected with an output shaft of the motor so that the motor drives the tray to rotate through the drive shaft.

8. The cooking appliance according to claim 7, wherein the drive shaft comprises a shaft member and a drive portion arranged coaxially with the shaft member, the shaft member is connected with the output shaft of the motor, the drive portion is formed with a plurality of drive teeth, and inter-teeth grooves are formed between adjacent drive teeth; and
a plurality of raised structures are formed at a bottom of the tray, and each of the raised structures is arranged in a corresponding one of the inter-teeth grooves.

9. The cooking appliance according to claim 7, wherein the motor bracket is a hood-shaped structure, a cavity is formed between the motor bracket and the bottom plate, and a through hole communicating with the cavity is provided on the motor bracket.

10. The cooking appliance according to claim 1, wherein the cooking appliance further comprises a rotating ring arranged between the bottom plate and the tray, and the rotating ring comprises a ring-like body and a plurality of rollers connected to the ring-like body.
